(19) United States
(12) Patent Application Publication
(10) Pub. No.: US 2023/0281431 A1
(43) Pub. Date: Sep. 7, 2023

(54) Computer implemented method for processing structured data

(71) Applicant: UNIVERSITAT POMPEU FABRA, Barcelona (ES)

(72) Inventors: Marcelo Jose BERTALMIO BARATE, Barcelona (ES); Alexander GOMEZ VILLA, Barcelona (ES); Adrian MARTIN FERNANDEZ, Barcelona (ES); Javier VAZQUEZ CORRAL, Barcelona (ES)

(21) Appl. No.: 18/006,730

(22) PCT Filed: Jul. 26, 2021
(86) PCT No.: PCT/EP2021/070817

§ 371 Date: Jan. 25, 2023

(30) Foreign Application Priority Data
Jul. 27, 2020 (EP) 20382676.3

(51) Int. Cl. G06N 3/048; G06N 3/08

(52) U.S. Cl. CPC G06N 3/048; G06N 3/08

(57) ABSTRACT

The present invention is related to a computer implemented method for processing structured data, wherein the method is based on an artificial neural network at least comprising a neural unit with a receptive field that combines the input values in a non-linear manner.

The method is a specific machine learning method wherein the structured data may be for instance sound streams or images. The method, according to specific embodiments may be applied to multi-channel structured data.

### FIELD OF THE INVENTION

The present invention is related to a computer implemented method for processing structured data, wherein the method is based on an artificial neural network at least comprising a neural unit with a receptive field that combines the input values in a non-linear manner.

The method is a specific machine learning method wherein the structured data may be for instance sound streams or images. The method, according to specific embodiments may be applied to multi-channel structured data.

### PRIOR ART

One of the technical fields with a more intensive development are methods and devices implementing machine learning algorithms performing tasks without being explicitly programmed to do so. Some applications of machine learning processes are text recognition, image recognition, sound processing, or those related with data mining.

Machine learning algorithms are based on a model that may be inspired on nature. The most common model is the one based on artificial neural network (ANNs) which is inspired on the biological structure of the brain. The brain comprises a huge amount of biological neurons wherein each neuron receives information from a plurality of dendrites. Dendrites transfer the inputted signal to the main body of the neuron which combines the information received in the whole set of dendrites. The neuron provides an output signal at the axon that is transferred to other neurons.

An ANN is a model based on a collection of connected units called artificial neurons wherein in this description the term “neural unit” will be used.

The plurality of neural units are arranged in layers wherein each neural unit transmits information from the receptive field comprising a plurality of inputs to the output.

In common ANN implementations, the signal at a connection between artificial neurons is a real number, that is, an artificial neuron receives a plurality of signals that are linearly combined according to a set of weights (the weights form a so-called receptive field (RF)) and is processed generating a new real number. The output of each artificial neuron is computed by some non-linear function of the sum of its inputs, resulting on the whole in a linear+nonlinear formulation.

The connections between artificial neurons are called “edges”. Artificial neurons and edges typically have a weight that adjusts as learning proceeds. The weight increases or decreases the strength of the signal at a connection. Neural units may have a threshold such that the signal is only sent if the aggregate signal crosses that threshold.

As it has been disclosed, artificial neurons are aggregated into layers. Different layers may perform different kinds of transformations on their inputs. Signals travel from the first layer (the input layer) to the last layer (the output layer), possibly after traversing intermediate layers.

Artificial neural networks are inspired on nature and, some of the applications are also inspired on specific biological structures like those allowing vision. Computer vision is a very important technical field wherein the core of the techniques are based on ANNs.

For all species, adaptation is a key property that any neural system must have; in particular in the human visual system it is present in all stages, from the photoreceptors in the retina all the way to the cortex.

Adaptation constantly adjusts the sensitivity of the visual system to the properties of the stimulus, bringing the survival advantage of making perception approximately independent from lighting conditions while quite sensitive to small differences among neighboring regions; this happens at very different timescales, from days and hours down to the 100 ms interval between rapid eye movements, when retinal neurons adapt to the local mean and variance of the signal, approximating histogram equalization. In this way, adaptation allows to encode neural signals with less redundancy, and is therefore an embodiment of the efficient representation principle, an ecological approach for vision science that has proven to be extremely successful across mammalian, amphibian and insect species and that states that the organization of the visual system in general and neural responses in particular are tailored to the statistics of the images that the individual typically encounters, so that visual information can be encoded in the most efficient way, optimizing the limited biological resources.

The visual system is nonlinear. It can be shown that the linear receptive field can't be a fixed, constant property of a neuron. It is visual adaptation which modifies the spatial receptive field and temporal integration properties of neurons depending on the input; in fact, under a basic linear+nonlinear formulation, adaptation simply means “a change in the parameters of the model”.

The linear receptive field limitations in predicting neuron responses to complex stimuli have been known for many years, and a wide variety of approaches have been introduced to model the nonlinear nature of visual phenomena, e.g. divisive normalization, feedback connections, neural-field equations, hierarchical models, fitting ANNs to visual data, or training ANNs to perform a high-level visual tasks, to name some of the most relevant lines of research.

However, all these approaches are still grounded in the notion of a linear receptive field. State-of-the-art vision models and ANNs, with their linear receptive fields, have very important weaknesses in their predictive powers.

In visual perception and color imaging, the general case of the image appearance problem is very much open: for natural images under given viewing conditions, there aren't neither fully effective automatic solutions nor accurate vision models to predict image appearance, not even in controlled scenarios like cinema theaters. This is a very important topic for imaging technologies, which require good perception models in order to encode image information efficiently and without introducing visible artifacts, for proper color representation, processing and display.

In computer vision, some of the well-known and most relevant problems of ANNs can be described as a failure to emulate basic human perception abilities. For instance ANNs are prone to adversarial attacks, where a very small change in pixel values in an image of some object A can lead the neural network to misclassify it as being a picture of object B, while for a human observer both the original and the modified images are perceived as being identical; this is a key limitation of ANNs, with an enormous potential for causing havoc.

Another example is that the classification performance of ANNs falls rapidly when noise or texture changes are introduced on the test images, while human performance remains fairly stable under these modifications. The difficulty of modeling vision with ANNs is a topic that is garnering increasing attention.

These drawbacks may also be identified in other fields wherein the structured data is a stream of sound transmitted in packages, images provided by an spectral camera having a plurality of channels, one channel per spectrum sensed by the camera, or signals wherein patterns must be identified and classified for instance in a data mining process. The invention overcomes the identified drawbacks by providing an specific nonlinear combination of the signals received at the input of at least one neural unit resulting in an advantageous ANN which mimics complex behaviors that ANNs according to the prior art are not able to provide.

### DESCRIPTION OF THE INVENTION

The present invention is a computer implemented method for processing structured data comprising:
a) deploying a neural network comprising at least one input stage and one output stage wherein
   each stage of the neural network comprises at least a neural unit;
   the set of stages of the neural network are consecutively connected,
   the at least one neural unit comprises:
      a receptive field comprising a plurality of input ports, and
      one output port;
b) receiving structured data into the input stage wherein datum locations x are indexed at least with one index i;
c) processing the inputted structured data in the neural network;
d) outputting the data outputted in the output stage;
characterized in that
e) the at least one neural unit provides an output value INRF on the output port depending on the values inputted in the input ports when processing data in a predetermined neighborhood N(x) of location x of the structured data provided to the stage of the neural unit, where x∈N(x), the output value being provided according to the following expression for the receptive field:

$$INRF ( x ) = {\sum }_{{y}_{i} ∈ N ( x )} {m}_{i} u ( {y}_{i} ) - λ {\sum }_{{y}_{i} ∈ N ( x )} {ω}_{i} σ ( u ( {y}_{i} ) - {\sum }_{{y}_{j} ∈ {N}_{k} ( x )} g ( {y}_{j} - x ) u ( {y}_{j} ) )$$

wherein
   yᵢ∈N(x) denotes the set of locations in the neighborhood N(x),
   yⱼ∈Nₖ(x) denotes the set of locations in the neighborhood Nₖ(x),
   u(yᵢ) denotes the values inputted in the input ports,
   mᵢ denotes m(x,yᵢ) in abbreviated form, the predetermined weights of a first kernel m(·) defined on the neighborhood N(x),
   ωᵢ denotes ω(x,yᵢ) in abbreviated form, the predetermined weights of a second kernel ω(·) defined on the neighborhood N(x),
   g(x,yⱼ) denotes the predetermined weights of third kernel g(·) defined on a predetermined second neighborhood Nₖ(x),
   λ is a non zero predetermined real value, and
   σ(·) denotes a predetermined non-linear real function.

The term structured data should be interpreted as data comprising at least a package of ordered data in a one-dimensional array or one or more multidimensional arrays wherein each package may be accessed by using an index.

A first example of structured data is a data stream of sound that may be split in one-dimensional arrays. A second example is a bi-dimensional image wherein each pixel may be accessed by two indexes.

In all cases, for each datum identified by at least one index, said datum has one or more data in the neighborhood with proximal indexes. The neighborhood is defined by the set of indexes identifying one or more data located in the proximity of one datum. The reference datum is deemed as being part of the neighborhood.

An equation is a specific relationship among variables. The same relationship or correspondence between variables may be expressed using different equations since such equations may be rewritten using different expressions while keeping the correspondence. For instance, the equation representing a circle may be expressed implicitly or using a parametric expression while the circle and the relationship between the x variable and the y variable is the same. In these cases, it is deemed that any expression setting the same dependency between variables will be interpreted as being equivalent.

The first step of the method deploys a neural network comprising a plurality of neural units arranged in stages, at least an input stage and an output stage. Stages are connected through the input ports of the receptive field of each neural unit. The input ports of the neural units of the input stage receive data from the inputted structured data. Any other inner stage or the output stage uses the data provided by the previous adjacent stage. That is, the set of stages of the neural network are stacked and consecutively connected since the receptive field of each stage is fed by the output of the neural units comprised in the previous stage.

Stages may be represented in a stacked manner wherein the information is sequentially transferred from one stage to the adjacent stage. The term adjacent, when referring to stages, will be interpreted as the next stage, given a reference stage, being directly connected to said reference stage.

The neural unit comprises a plurality of input ports receiving data from the previous stage that may be accessed by means of the at least one index.

Neural units provide an output value that is used in the next stage. The arrangement of neural units along a stage mimics the same structure of the input structured data and therefore is also indexed like in the input data. As a result, formulas involving indexes do not differentiate when data in the input port of a unit is read in the input structured data or is read in the output of an intermediate stage.

Input structured data is sequentially processed by the set of stages providing the output in the output stage.

The method is characterized in that the output value provided in the receptive field is:

$$INRF ( x ) = {\sum }_{{y}_{i} ∈ N ( x )} {m}_{i} u ( {y}_{i} ) - λ {\sum }_{{y}_{i} ∈ N ( x )} {ω}_{i} σ ( u ( {y}_{i} ) - {\sum }_{{y}_{j} ∈ {N}_{k} ( x )} g ( {y}_{j} - x ) u ( {y}_{j} ) )$$

The neural unit is at a certain location x and neighboring locations are identified as yⱼ. That is, when the input values are assessed in the neighboring locations that values are identified as u(yⱼ).

The first evaluation is Σ_{j∈N}_{ₖ}₍ₓ₎g(yⱼ−x)u(yⱼ), wherein each value received in each input port is multiplied by the third kernel g(·) which provides the weights for each location of the neighborhood. The kernel is defined at least for each location corresponding to an input port wherein Σ_{j∈N}_{ₖ}₍ₓ₎g(yⱼ−x)u(yⱼ) is a convolution of the inputted data with the third kernel. It should be noted that the term convolution is used because the shifted condition on the kernel located within the summation and it should be interpreted as the operation of the point-wise multiplication followed of all the resulting products as is typical in the neural network literature.

According to preferred embodiments, the weight values of the first kernel m(·), the weight values of the second kernel ω(·), and the weight values of the third kernel g(·) are the result of the training process wherein before the training process the stencil of each kernel must be defined.

The difference between the inputted data u(yⱼ) at location yⱼ and the resulting convolution is the argument of a non-linear real function σ at the receptive field.

According to a first embodiment, σ is a ramp function only for positive values, that is, a rectified linear unit (ReLu). That is, it may be expressed as σ(t)=m·t·h(t), being m a constant value preferably equal to 1 and wherein h(t) is the step function. According to other embodiments a is a polynomial expression.

According to another embodiment that may be combined with any of the former embodiments, the non-linear function σ(·) is a predetermined function that depends on one or more parameters wherein said one or more parameters are determined by the training process of the neural network (NN).

This non-linear combination of the inputted values is waited according to the weights provided by the second kernel ωᵢ in a neighborhood N(x). According to specific embodiments the neighborhood of the second kernel N(x) and the neighborhood of the third kernel Nₖ(x) are the same. According to other embodiments, the second kernel N(x) and the neighborhood of the third kernel Nₖ(x) are different depending on the specific application.

The resulting value of this weighting process is scaled by a λ, a real value. According to some embodiments, λ takes a value ranging from 0 to 1.7 wherein according to another embodiment λ takes a value ranging from 0 to 1.

According to another embodiment that may be combined with any of the former embodiments, λ is a parameter determined by the training process of the neural network (NN).

The resulting value of the INRF is the result of the difference between a further convolution of the input values u(yᵢ) and the first kernel and the former resulting value that has been scaled by λ.

The INRF value may be processed with a further module expressing the outputted value at the output port depending on the INRF value. For instance a non-linear function may be used for determining the response of the neural unit. According to other embodiments, a maxout layer is combined at the output of the stage comprising the neural unit.

The training process for an INRF-net is analogous to the one used for artificial and convolutional neural networks (ANNs and CNNs respectively). Any algorithm for first-order gradient-based optimization can be used in combination with the backpropagation algorithm and the automatic differentiation in order to compute internal derivatives.

In particular, for this implementation according to an example, the applicant has used the ADAM algorithm allowing to use stochastic objective functions.

According to an embodiment the third kernel g(·) is a delta function, being g(x,yⱼ)=1 if x=yⱼ and 0 otherwise, wherein INRF is:

$$INRF ( x ) = {\sum }_{{y}_{i} ∈ N ( x )} {m}_{i} u ( {y}_{i} ) - λ {\sum }_{{y}_{i} ∈ N ( x )} {ω}_{i} σ ( u ( {y}_{i} ) - u ( x ) )$$

According to this third kernel only those values multiplied by 1 are preserved and the rest of the inputted values are discarded. The resulting expression is simpler and allows a faster processing of the reception field.

According to an embodiment, the kernel m(·) whose elements are mᵢ and the kernel ω(·) whose elements are ωᵢ are the same kernel, wherein INRF may be expressed as:

$$INRF ( x ) = {\sum }_{{y}_{i} ∈ N ( x )} {ω}_{i} [ u ( {y}_{i} ) - λ σ ( u ( {y}_{i} ) - u ( x ) ) ]$$

In this embodiment a very fast evaluation in a single neighborhood is performed while keeping the non-linear behavior of the receptive field. The sum symbol is extended to the neighborhood only once.

According to another embodiment, the non-linear function σ(·) satisfies σ(0)=0. In this embodiment, a cero input in all the input ports of the receptive field provides a zero signal at the output.

According to another embodiment, σ(·) is a non-symmetrical function.

The preferred non-symmetrical function will show the form

$$f ( x ) = \{ \begin{matrix}{x}^{p} & if x \geq 0 \\ - {\vert x \vert}^{q} & otherwise\end{matrix}$$

In an specific embodiment p=0.7 and q=0.3.

According to an embodiment λ is within the range [0, 6] providing a larger output signal of the non-linear function. According to another embodiment the λ value is within the range [0, 1]. According to a specific application used for brightness perception the λ value is within the range [1, 6].

According to an embodiment, the structured data is among the following list:
a stream of data representing amplitudes of a physical property, split in packages of structured data Iᵢ that are indexed according to one index i;
a stream of data representing amplitudes of a physical property provided by a sensor;
a stream of data representing text, split in packages of structured data Iᵢ that are indexed according to one index i;
a stream of data representing DNA/RNA/genome, split in packages of structured data Iᵢ that are indexed according to one index i;
a stream of data, split in packages of structured data Iᵢ that are indexed according to one index i, representing a financial quantity;
the previous stream of data representing sound data;
a bi-dimensional tensor Iᵢⱼ indexed with two indexes;
a three-dimensional tensor Iᵢⱼₖ indexed with three indexes;
a bi-dimensional image Iᵢⱼ comprising pixels indexed with two indexes; or
a three-dimensional image Iᵢⱼₖ comprising voxels indexed with three indexes.

The first example corresponds to an example of one-dimensional data obtained by sampling of a measurement of a one-dimensional physical property in time such as a pressure measurement, a temperature measurement or a sample of sound.

According to an embodiment, the stream of data is split in packages that may correspond to predetermined periods of samples allowing to classify such packages by using the ANN.

According to another embodiment, the structured data is a bi-dimensional image (for instance denoted as Iₘₙ) wherein two indexes m,n allow to identify a given pixel in the image. In this embodiment, the indexes used in kernels and appearing in the expressions of INRF(x) are different to these two indexes. According to the defined notation, when referring to the neighborhood, the single index i used yᵢ∈N(x) involves a plurality of pairs of indexes (m,n) of the bi-dimensional image Iₘₙ.

Given a pixel pₘₙ with coordinates mn in the image, the location in the image determined by indexes mn is the location of x in the given formula for INRF. The neighboring pixels providing values u(yⱼ) j=1 . . . N would be in the form (Pₘₙ, Pₘ₊₁ₙ, Pₘ₋₁ₙ, Pₘₙ₊₁, Pₘₙ₋₁, Pₘ₊₁ₙ₊₁, . . . taking into account all the surrounding pixels of the neighborhood and being also covered by index j.

Another embodiment comprises three-dimensional data such as three-dimensional images comprising voxels. The same explanation provided for the indexes of the bi-dimensional image applies mutatis mutandis for the three-dimensional image wherein the index j now refers to voxels identified in the image with three indexes.

According to another embodiment the structured data comprises a plurality of input channels C wherein the INRF(x) on a location x combines the information of the plurality of channels wherein the INRF(x) may be expressed as:

$$INRF ( x ) = {\sum }_{c = 1}^{C} ( {\sum }_{{y}_{i} ∈ N ( x )} {m}_{i}^{c} {u}^{c} ( {y}_{i} ) - λ {\sum }_{{y}_{i} ∈ N ( x )} {ω}_{i}^{c} σ ( {u}^{c} ( {y}_{i} ) - {\sum }_{{y}_{j} ∈ {N}_{k} ( x )} {g}^{c} ( {y}_{j} - x ) {u}^{c} ( {y}_{j} ) ) )$$

wherein
index c identifies the number of the input channel;
u^{c}(yᵢ) denotes the values inputted in the input ports pᵢ for the c^{th} channel;
mᵢ^{c} denotes m^{c}(x,yᵢ) in abbreviated form, the predetermined weights of a first kernel m(·) for the c^{th} input channel;
ωᵢ^{c} denotes ω^{c}(x,yᵢ) in abbreviated form, the predetermined weights of a second kernel ω(·) for the c^{th} input channel;
g^{c} denotes the predetermined weights of third kernel g(·) for the c^{th} channel; and
the neighborhoods N(x) and Nₖ(x) are common for all input channels.

The formula INRF(x) now further comprises data combining information of the C channels. For a predetermined channel the formula is the same as the one used when only one-channel is present. The resulting INRF(x) is a contribution from each channel.

This neural unit is suitable for connecting a stage or input data comprising C channels and provides a single channel which gathers the information weighted on all the input channels.

According to another embodiment the stage comprising the neural unit (NU) comprises D output channels, and the INRF comprising D components INRF¹, INRF², . . . , INRF^{D} provided at the output port (out) wherein the d^{th} component, 1≤d≤D, may be expressed as:

$${INRF}^{d} ( x ) = {\sum }_{c = 1}^{C} ( {\sum }_{{y}_{i} ∈ N ( x )} {m}_{i}^{cd} {u}^{c} ( {y}_{i} ) - λ {\sum }_{{y}_{i} ∈ N ( x )} {ω}_{i}^{cd} σ ( {u}^{c} ( {y}_{i} ) - {\sum }_{{y}_{j} ∈ {N}_{k} ( x )} {g}^{cd} ( {y}_{j} - x ) {u}^{c} ( {y}_{j} ) ) )$$

wherein
index c identifies the number of the input channel;
u^{c}(yᵢ) denotes the values inputted in the input ports pᵢ for the c^{th} channel;
mᵢ^{cd} denotes m^{cd}(x,yᵢ) in abbreviated form, the predetermined weights of a first kernel m(·) for the c^{th} input channel and d^{th} output channel;
ωᵢ^{cd} denotes ω^{cd}(x,yᵢ) in abbreviated form, the predetermined weights of a second kernel ω(·) for the c^{th} input channel and d^{th} output channel;
g^{cd} denotes the predetermined weights of third kernel g(·) for the c^{th} input channel and d^{th} output channel; and
the neighborhoods N(x) and Nₖ(x) are common for all channels.

A neural unit having an output INRF^{d}(x) is suitable to connect an input stage or data comprising C channels with an output stage comprising D channels. Each output channel has the value of the d^{th} component of the vectorial output INRF^{d}(x).

The preferred embodiment uses the same typology of neural units in each stage.

A further aspect of the invention is the use of a deployed neural network according to step a) of the method wherein at least one neural unit is according to feature e).

A further aspect of the invention is a computer program product comprising instructions which, when the program is executed by a computer, cause the computer to carry out any previously disclosed method.

### DESCRIPTION OF THE DRAWINGS

These and other features and advantages of the invention will be seen more clearly from the following detailed description of a preferred embodiment provided only by way of illustrative and non-limiting example in reference to the attached drawings.

FIG. 1 This figure shows a schematic representation of an INRF neural network.

FIG. 2 This figure shows a schematic view of an example of the neural unit.

FIGS. 3A-3E These figures show an schematic representation of an image as input data and several embodiments of stencils for the receptive field of the neural unit.

FIG. 4 This figures shows a schematic view of the input values and the index representation used along the description.

FIG. 5 This figure shows a schematic representation of an intermediate evaluation of the INRF value.

FIG. 6 This figure shows the last step of the evaluation of the INRF value in an embodiment of the invention.

FIG. 7 This figure shows a L+NL model wherein it is shown how said model is not able to replicate the psychophysical data for the salt and pepper experiment.

### DETAILED DESCRIPTION OF THE INVENTION

As will be appreciated by one skilled in the art, aspects of the present invention may be embodied as a system, method or computer program product.

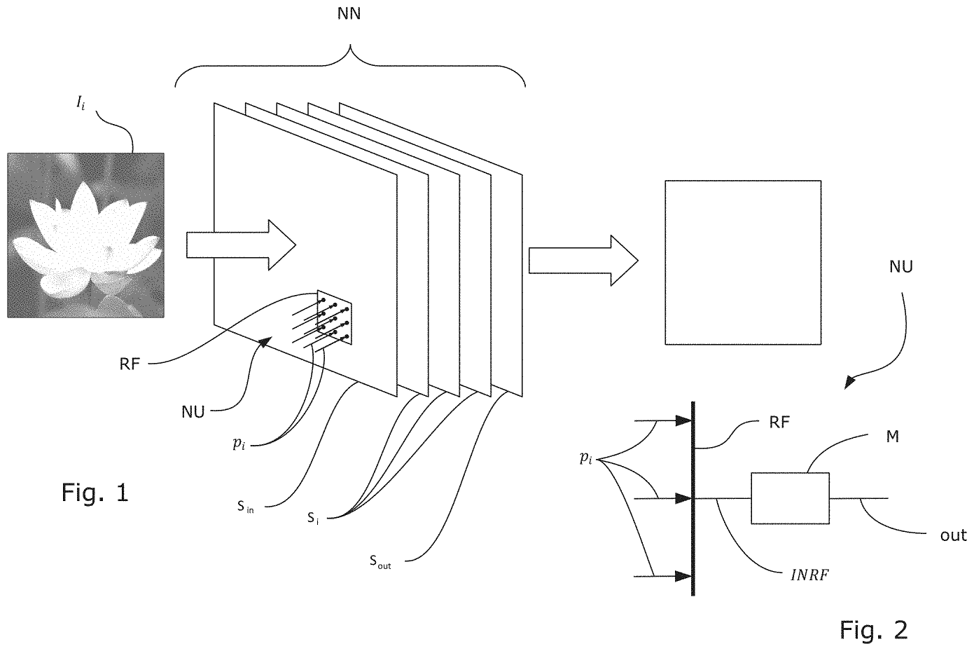

FIG. 1 shows a schematic representation of an INRF neural network (NN) comprising a plurality of stacked connected stages (Sᵢₙ, Sᵢ, Sₒᵤₜ). Each stage is an arrangement of at least one neural unit (NU). Disclosed embodiments will use stages (Sᵢₙ, Sᵢ, Sₒᵤₜ) comprising a two-dimensional distribution adapted to process two-dimensional images.

The first stage is the input stage (Sᵢₙ) and the last stage is the output stage (Sₒᵤₜ). The neural network (NN) therefore ends in a multistage perceptron. In this setting, the stack of stages (Sᵢₙ, Sᵢ, Sₒᵤₜ) acts as a feature extractor that feeds a vector to the multistage perceptron or classifier. The vector is a specific structured data Iᵢ introduced into the input stage (Sᵢₙ) wherein datum locations x are indexed at least with one index i.

A very common structured data is an image as the one represented in the left side of FIG. 1. The input stage (Sᵢₙ) receiving the image shows schematically a set of input ports (pᵢ) of a neural unit (NU).

According to this embodiment, the input stage (Sᵢₙ) comprises the same number of neural units (NU) as pixels showing the same arrangement than the arrangement of the pixels of said bi-dimensional image. That is, there is a bijective correspondence between each pixel of the image and each neural unit (NU) of the input stage (Sᵢₙ).

The input ports (pᵢ) of a neural unit (NU) shown in FIG. 1 are distributed in a matrix form with three rows and three columns. This matrix form is an embodiment of representation of the input ports (pᵢ) for receiving nine values in the receptive field (RF) of the neural unit (NU). Other distributions are used depending on the application and the input data. For instance, the input ports (pᵢ) may show more complex stencils (St) involving more data being represented by a larger matrix. In this embodiment a 3×3 matrix has been chosen for simplicity. In the embodiments, the reference coordinate of the neural unit (NU) will be the coordinate of the corresponding pixel of the image, being also the location of the input port (pᵢ) located in the central position among the nine input ports (pᵢ).

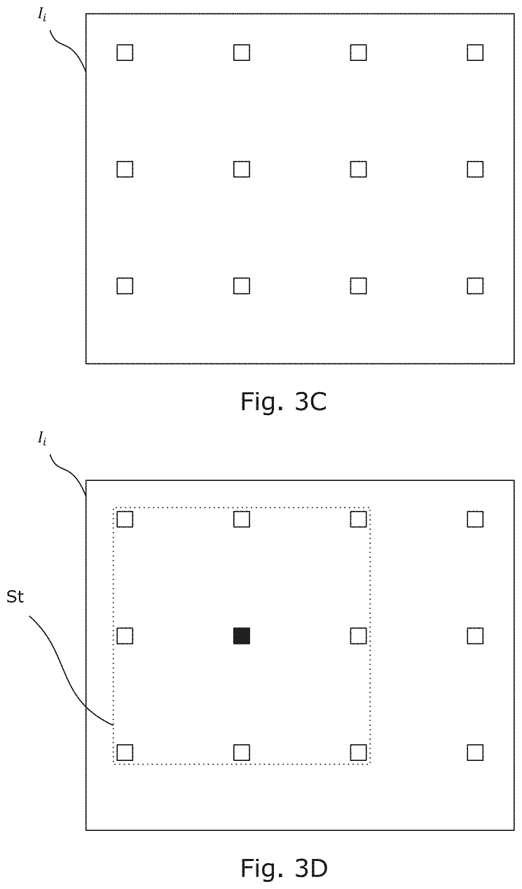

In FIG. 3A the stencil (St) identifying the 3×3 matrix is represented by a square housing the 3×3 pixels using dashed lines. Pixels, for the sake of simplicity, are represented by small squares arranged in rows and columns within the image (Iᵢ). The reference coordinate x of the neural unit (NU) corresponding to the stencil (St) is shown in black wherein in these embodiments is located in the center of the stencil (St).

That is, each neural unit (NU) located at location x receives information throughout the input ports (pᵢ) from the corresponding pixel al location x of the image and form the plurality of pixels located nearby according to the stencil (St) defined by the matrix.

When location x is in the limit of the image (Iᵢ), those input ports (pᵢ) located out of the image (Iᵢ) are not connected or discarded. In practice, a 0 value is used or those pixels that would be read out of the image are not taken into account. FIG. 3A also shows this particular situation at the left side.

Since each pixel has associated a neural unit (NU), the processing of all neural units (NU) may be processed in a concurrent manner increasing the processing speed.

In a specific embodiment, a single neural unit (NU) is instantiated in a specific stage and the single neural unit (NU) sweeps all pixels of the image (Iᵢ), providing a value for each pixel requiring a reduced amount of memory requirements.

According to another alternative embodiment, shown in FIG. 3B, the single neural unit (NU) sweeps a selection of pixels of the image that is taken as the reference location.

At a given stage, the pattern of selected pixels (or values) being processed by a neural unit (NU) is the output pattern of the stage. This output pattern is the input pattern of available values that may be processed (all output values or a subsequent selection of output values) by the next stage (Sᵢ, Sₒᵤₜ). This next stage (Sᵢ, Sₒᵤₜ) may be processed by a plurality of neural units (NU), one per selected output value at the input side of the stage or, alternatively a single neural unit (NU) sweeping all selected output values.

FIG. 3C shows the pattern of the selected pixels that is the same pattern of the outputted values. This arrangement of outputted values is the arrangement inputted into the next stage (Sᵢ, Sₒᵤₜ). FIG. 3D shows a 3×3 stencil (St) used by the receptive field (RF) of a neural unit (NU) of the next connected stage (Sᵢ, Sₒᵤₜ) applied to the outputted values.

FIG. 3E shows the preferred embodiment wherein all pixels are reference locations x of one neural unit (NU) or, the same neural unit (NU) sweeps all pixels at the same stage. Because of this, all pixels are shown in black.

The squares representing the stencil (St) of a plurality of neural units (NU) are overlapping since according to this preferred embodiment a pixel provides information to a plurality of neural units (NU) since said pixel is housed in a plurality of stencils (St). Only a few squares, three pixels shown in gray, representing the stencil (St) are shown overlapping because representing the whole set of stencils (St) would result in an unclear figure.

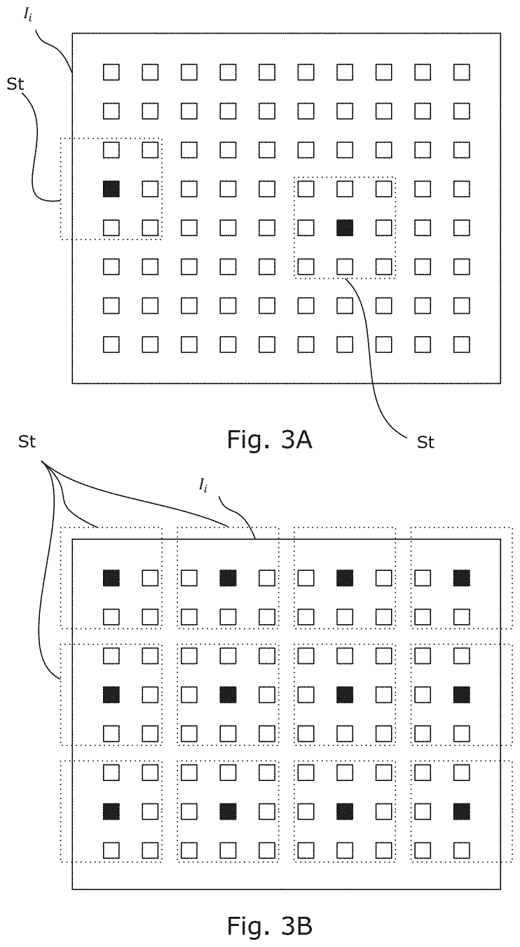

FIG. 2 shows a schematic view of a neural unit (NU) wherein at the left side the input arrows identify the locations where the neural unit (NU) reads the input values u(yᵢ) in its receptive field (RF).

The output value of the neural unit (NU) after the receptive field (RF) is an output port (out). This output port may provide the INRF(x) value that will be determined according to an embodiment of the invention or provide one or more intermediate modules (M) introducing a correspondence between the output value and the INRF(x) value. An example of module (M) is a module implementing a non-linear function.

According to other embodiments, the neural network (NN) may comprise intermediate layers such as a pooling layer, a batch normalization layer, a maxout layer or dropout layer.

According to a general expression, the INFR(x) value is determined by

INRF(x)=Σ_{y}_{ᵢ}_{∈N(x)}mᵢu(yᵢ)−λΣ_{y}_{ᵢ}_{∈N(x)}ωᵢσ(u(yᵢ)−Σ_{y}_{ⱼ}_{∈N}_{ₖ}₍ₓ₎g(yⱼ−x)u(yⱼ)).

According to an embodiment, the INRF(x) expression may be simplified as

$$INRF ( x ) = {\sum }_{{y}_{i} ∈ N ( x )} {ω}_{i} [ u ( {y}_{i} ) - λ σ ( u ( {y}_{i} ) - u ( x ) ) ]$$

wherein ωᵢ denotes the predetermined weights of a second kernel defined in a neighborhood N(x) of location x; λ is a real value, preferably a value greater than 1, u(x) the data value at location x, and u(yᵢ) data value at each location of the neighborhood N(x) wherein in this embodiment y₅=x.

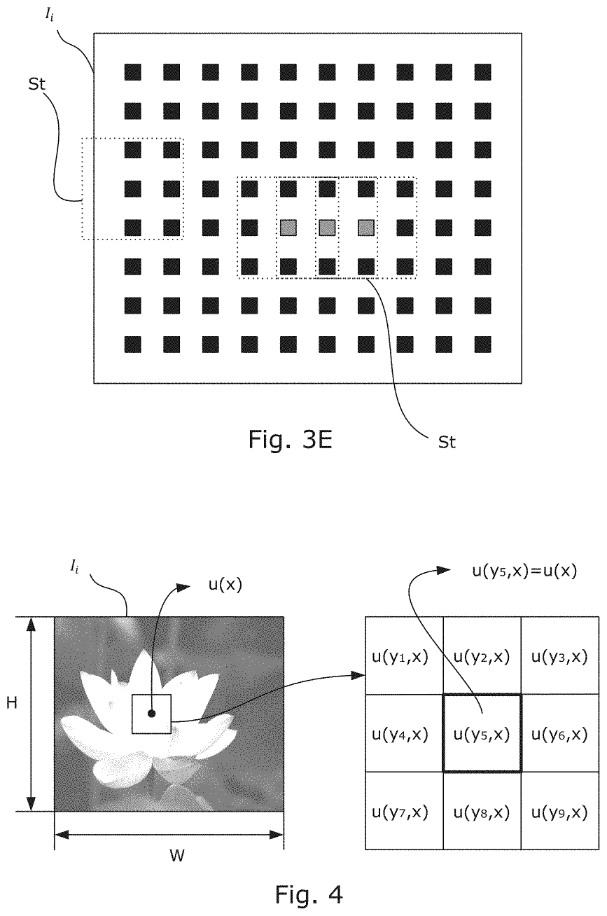

FIG. 4 shows an input structured data Iᵢ in the form of an image W wide and H high. In this embodiment, a 3×3 stencil (St) will be used for simplicity. The x location identifies a specific pixel in which the stencil (St) is centered and u(x) is the pixel value corresponding to location x. The eight surrounding pixels may be indexed with two indexes, a first index identifying the horizontal coordinate and a second index identifying the vertical coordinate. On the contrary, to facilitate the notation, a single index will be used running for all pixel values included in the neighborhood N(x)=Nₖ(x). At the right side of FIG. 4 each pixel corresponding to the neighborhood is identified with coordinates yᵢ i=1, . . . , 9 and wherein y₅=x and a second coordinate x indicating that the stencil (St) is centered in that specific location.

The input data provided to the input stage (Sᵢₙ) receives the named image and the term pixel is used for the values represented by said image. In any intermediate stage (Sᵢ) or the output stage (Sₒᵤₜ) the input values in this embodiment are structured also in two dimensions and processed in the same manner but such values are not necessarily identified with an image. For instance, values outputted as represented in FIGS. 3C and 3D are not images but intermediate values at a certain intermediate stage (Sᵢ) of the process of the neural network (NN).

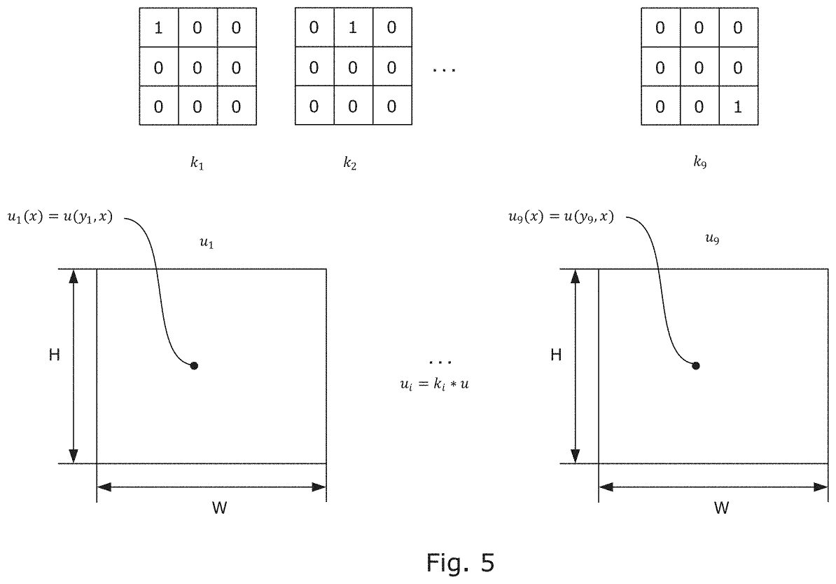

In order to ease the computation of our approach, we define a set of kernels k₁, k₂, . . . , k₉ as shown in FIG. 5. These kernels facilitate the simultaneous computation in matrix form of the INRF(x) by producing the matrices u₁, . . . , u₉ that contains for each location x the pixels of its neighborhood from left to right and from top to bottom, i.e. uᵢ(x)=u(yᵢ,x)=(kᵢ*u)(x).

Using u₁, . . . , u₉ an intermediate result in the form of 9 other matrices vᵢ=1, . . . , 9 is calculated using the following pointwise operation:

vᵢ(x)=uᵢ(x)−λσ(uᵢ(x)−u(x)).

Finally, each of these matrices vᵢ, i=1, . . . , 9 is multiplied by the value wᵢ, i=1, . . . , 9 of the second kernel w to obtain the output value INRF for each location:

$$INRF ( x ) = {\sum }_{i = 1}^{9} {w}_{i} \cdot {v}_{i} ( x )$$

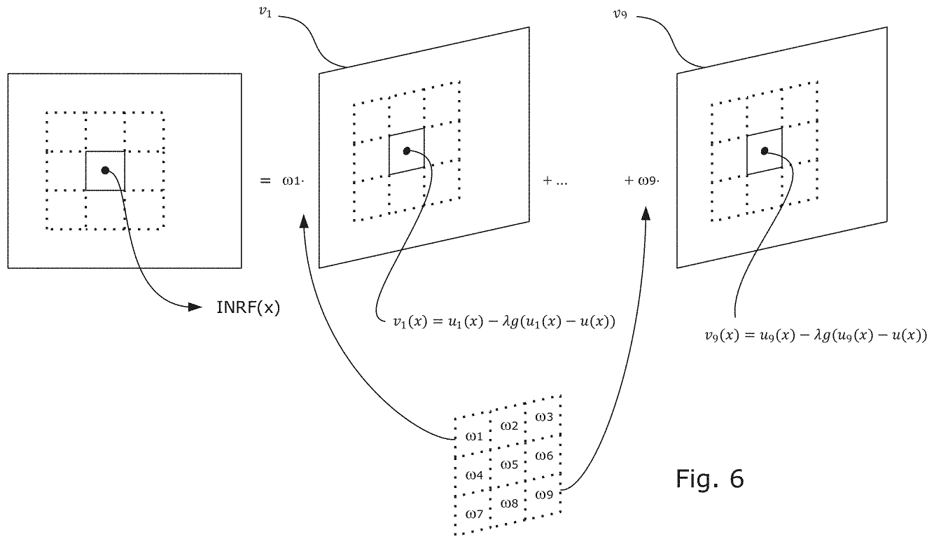

FIG. 6 shows an interpretation of this last operation. The scheme shown in FIG. 6 clearly shows that the INFR(x) involves the nine intermediate images determined from a neighborhood N(x) of the receptive field (RF) but each of the vᵢ intermediate images is the result of a non-linear expression involving the convolution of the input values u(yᵢ).

It should be noted that the nonlinear function σ(·) is used in the inner part of the receptive field (RF) and therefore, the general behavior or the neural unit (NU) may not be reproduced by combining a linear weighted input plus a nonlinear function applied to said linear weighted input.

The proposed INRF(x) can model different vision properties, such as the irradiation illusion or the noise masking in White's illusion, that are not possible to model using a single linear receptive field followed by a non-linearity. Therefore, a key property of wide-ranging implications of the INRF is that in cases where the linear receptive field (RF) must vary with the input in order to predict responses, the INRF(x) proposed can remain constant under different stimuli.

Another case of the above explained is the modeling of the psychophysical experiment of the “crispening” effect in visual perception. In this experiment participants are asked to adjust the luminance values of a series of circular patches lying over a uniform surround until all brightness steps from one circle to the next are perceived to be identical from black to white, i.e. observers create a uniform brightness scale. When the brightness perception is represented as a curve depending on the real luminance, the slope of the brightness perception curve increases around the luminance level of the surround. This effect is called “crispening”, and it's a very complicated perceptual phenomenon to model as it is very much dependent on the input. For instance, if in the experiment above the uniform surround is replaced by salt and pepper noise of the same average, the crispening virtually disappears.

It has been proven that the same INRF(x), i.e. using a fixed set of parameters for the model, can adequately predict how crispening happens with uniform background and how it is abolished when the background is salt and pepper noise. An extremely simple brightness perception model consists of just two stages: the first one is a Naka-Rushton equation to model photoreceptor response, and the second step is the INRF(x) according to the invention that models the responses of retinal ganglion cells, where kernels m,w are Gaussians, g is a Dirac delta and the nonlinearity modeled by σ(·) is an asymmetric sigmoidal function with different exponents for the positive and negative regions.

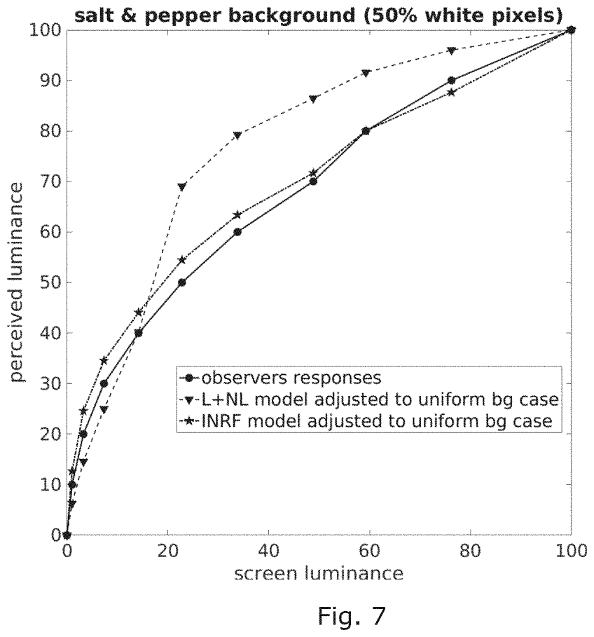

If, after the Naka-Rushton stage, one were to use the classical L+NL (linear+nonlinear) formulation with a Difference of Gaussians (DoG) kernel and a pointwise nonlinearity instead of the INRF(x), it would be possible to optimize its parameters so that the L+NL model fits the psychophysical data and predicts crispening for the uniform background condition. But then, as seen in FIG. 7, this L+NL model is not able to replicate the psychophysical data for the salt and pepper surround (dashed line with triangles). It still predicts crispening in this case, when for observers crispening has disappeared. This problem does not occur for INRF(x) (dash-dotted line with stars) in which the model fitted for the uniform background condition also works well in the salt and pepper noise condition.

Finally, it has been tested an embodiment where a convolutional neural network (CNN) is modified replacing each of the convolution operations with linear filters and bias by a INRF(x) according to the invention while keeping all other elements of the architecture the same and maintaining the number of free parameters, then training this new network and comparing the performance with the original CNN. This experiment have been done for an image classification task, using two architectures and the four benchmark databases that are regularly used in the literature.

TABLE 1

| Dataset | CNN | INRFnet |
|---|---|---|
| MNIST | 0.48 | 0.43 |
| CIFAR10 | 24.28 | 16.78 |
| CIFAR100 | 57.01 | 48.8 |
| SVHN | 6.26 | 3.41 |

As shown in Table 1, in all cases the INRF-based neural network (INRFnet) outperforms the CNN in terms of classification error, with wide improvements that go from 10% for MNIST to a remarkable 45% for SVHN. Preliminary tests on a 20-layer residual network using the CIFAR10 dataset show a 5% improvement for the INRF network over the CNN, from 9.4% error down to 8.9%. It has been also subjected the INRF-based neural network to four different forms of adversarial attacks, and in all cases it's remarkably more robust than the CNN, as shown in Tables 2 and 3.

TABLE 2
Accuracy against whitebox adversarial attacks on the MNIST dataset.

| Attack | FGSM | FGSM | FGSM | | Carlini-Wagner | Carlini-Wagner |
|---|---|---|---|---|---|---|
| methods | (ε = 0.1) | (ε = 0.2) | (ε = 0.3) | DeepFool | (L₂) | (L_{∞}) |
| CNN | 88.14% | 44.69% | 11.03% | 52.01% | 4.18% | 42.5% |
| INRFnet | 93.14% | 62.23% | 33.42% | 65.27% | 7.24% | 58.06% |

TABLE 3
Accuracy against whitebox adversarial
attacks on the CIFAR10 dataset.

| Attack | FGSM | FGSM | FGSM | |
|---|---|---|---|---|
| methods | (ε = 0.05) | (ε = 0.1) | (ε = 0.15) | DeepFool |
| CNN | 13.27% | 12.26% | 10.79% | 47.63% |
| INRFnet | 19.3% | 16.6% | 15.6% | 57.46% |

This method may be generalized for structured data comprising a plurality of channels, wherein the u(yᵢ) values comprises a plurality of C channels and, the kernel expressions are generalized also comprising a new dimension.

$$INRF ( x ) = {\sum }_{c = 1}^{C} ( {\sum }_{{y}_{i} ∈ N ( x )} {m}_{i}^{c} {u}^{c} ( {y}_{i} ) - λ {\sum }_{{y}_{i} ∈ N ( x )} {ω}_{i}^{c} σ ( {u}^{c} ( {y}_{i} ) - {\sum }_{{y}_{j} ∈ {N}_{k} ( x )} {g}^{c} ( {y}_{j} - x ) {u}^{c} ( {y}_{j} ) ) )$$

According to this expression, the INRF(x) involves the information of all the input channels and provides a scalar value.

The method according to the invention may also be applied to an input structured data comprising a plurality of C channels and providing D channels wherein each channel at the output side has a separate INRF(x) value. In this specific embodiment the INRF(x) expression is a vector:

$${INRF}^{d} ( x ) = {\sum }_{c = 1}^{C} ( {\sum }_{{y}_{i} ∈ N ( x )} {m}_{i}^{cd} {u}^{c} ( {y}_{i} ) - λ {\sum }_{{y}_{i} ∈ N ( x )} {ω}_{i}^{cd} σ ( {u}^{c} ( {y}_{i} ) - {\sum }_{{y}_{j} ∈ {N}_{k} ( x )} {g}^{cd} ( {y}_{j} - x ) {u}^{c} ( {y}_{j} ) ) )$$

1. Computer implemented method for processing structured data, specifically an image, a bi-dimensional image Iᵢⱼ comprising pixels indexed with two indexes, or a three-dimensional image Iᵢⱼₖ comprising voxels indexed with three indexes, comprising:
a) deploying a neural network (NN) comprising at least one input stage (Sᵢₙ) and one output stage (Sₒᵤₜ) wherein
each stage (Sᵢₙ, Sᵢ, Sₒᵤₜ) of the neural network (NN) comprises at least a neural unit (NU);
the set of stages of the neural network (NN) are stacked and consecutively connected,
the at least one neural unit (NU) comprises:
a receptive field (RF) comprising a plurality of input ports (pᵢ), and
one output port (out);
b) receiving structured data Iᵢ representing an image into the input stage wherein datum locations x are indexed at least with one index i;
c) processing the inputted structured data in the neural network (NN);
d) outputting the data outputted in the output stage;
characterized in that
e) the at least one neural unit (NU) provides an output value INRF on the output port (out) depending on the values inputted in the input ports (pᵢ) when processing data in a predetermined neighborhood N(x) of location x of the structured data provided to the stage (Sᵢₙ, Sᵢ, Sₒᵤₜ) of the neural unit (NU), where x∈N(x), the output value being provided according to the following expression for the receptive field:
$$INRF ( x ) = {\sum }_{{y}_{i} ∈ N ( x )} {m}_{i} u ( {y}_{i} ) - λ {\sum }_{{y}_{i} ∈ N ( x )} {ω}_{i} σ ( u ( {y}_{i} ) - {\sum }_{{y}_{j} ∈ {N}_{k} ( x )} g ( {y}_{j} - x ) u ( {y}_{j} ) )$$
wherein
yᵢ∈N(x) denotes the set of locations in the neighborhood N(x),
yⱼ∈Nₖ(x) denotes the set of locations in the neighborhood Nₖ(x),
u(yᵢ) denotes the values inputted in the input ports pᵢ,
mᵢ denotes m(x,yᵢ) in abbreviated form, the predetermined weights of a first kernel m(·) defined on the neighborhood N(x),
ωᵢ denotes ω(x,yᵢ) in abbreviated form, the predetermined weights of a second kernel ω(·) defined on the neighborhood N(x),
g(x,yⱼ) denotes the predetermined weights of third kernel g(·) defined on a predetermined second neighborhood Nₖ(x),
λ is a non zero predetermined real value, and
σ(·) denotes a predetermined non-linear real function.

2. A method according to claim 1, wherein the third kernel g(·) is a delta function, being g(x,yⱼ)=1 if x=yⱼ and 0 otherwise, wherein INRF is:
$$INRF ( x ) = {\sum }_{{y}_{i} ∈ N ( x )} {m}_{i} u ( {y}_{i} ) - λ {\sum }_{{y}_{i} ∈ N ( x )} {ω}_{i} σ ( u ( {y}_{i} ) - u ( x ) )$$

3. A method according to claim 2, wherein the first kernel m(·) whose elements are mᵢ and the second kernel ω(·) whose elements are ωᵢ are the same kernel, wherein INRF may be expressed as:
$$INRF ( x ) = {\sum }_{{y}_{i} ∈ N ( x )} {ω}_{i} [ u ( {y}_{i} ) - λ σ ( u ( {y}_{i} ) - u ( x ) ) ]$$

4. A method according to claim 1, wherein the non-linear function σ(·) satisfies σ(0)=0.

5. A method according to claim 1, wherein the σ(·) is a non-symmetrical function, preferably in the form
$$f ( x ) = \{ \begin{matrix}{x}^{p} & if x \geq 0 \\ - {\vert x \vert}^{q} & otherwise\end{matrix}$$
wherein p and q are positive real values.

6. A method according to claim 1, wherein λ is within the range [0, 6].

7. (canceled)

8. A method according to claim 1, wherein the structured data comprises a plurality of input channels C wherein the INRF on a location x combines the information of the plurality of channels wherein the INFR may be expressed as:
$$INRF ( x ) = {\sum }_{c = 1}^{C} ( {\sum }_{{y}_{i} ∈ N ( x )} {m}_{i}^{c} {u}^{c} ( {y}_{i} ) - λ {\sum }_{{y}_{i} ∈ N ( x )} {ω}_{i}^{c} σ ( {u}^{c} ( {y}_{i} ) - {\sum }_{{y}_{j} ∈ {N}_{k} ( x )} {g}^{c} ( {y}_{j} - x ) {u}^{c} ( {y}_{j} ) ) )$$
wherein
index c identifies the number of the input channel;
u^{c}(yᵢ) denotes the values inputted in the input ports pᵢ for the c^{th} channel;
mᵢ^{c} denotes m^{c}(x,yᵢ) in abbreviated form, the predetermined weights of a first kernel m(·) for the c^{th} input channel;
ωᵢ^{c} denotes ω^{c}(x,yᵢ) in abbreviated form, the predetermined weights of a second kernel ω(·) for the c^{th} input channel;
g^{c} denotes the predetermined weights of third kernel g(·) for the c^{th} channel; and
the neighborhoods N(x) and Nₖ(x) are common for all input channels.

9. A method according to claim 1, wherein the stage (Sᵢₙ, Sᵢ, Sₒᵤₜ) comprising the neural unit (NU) comprises D output channels, and the INRF comprising D components INRF¹, INRF², . . . , INRF^{D} provided at the output port (out) wherein the d^{th} component, 1≤d≤D, may be expressed as:
$${INRF}^{d} ( x ) = {\sum }_{c = 1}^{C} ( {\sum }_{{y}_{i} ∈ N ( x )} {m}_{i}^{cd} {u}^{c} ( {y}_{i} ) - λ {\sum }_{{y}_{i} ∈ N ( x )} {ω}_{i}^{cd} σ ( {u}^{c} ( {y}_{i} ) - {\sum }_{{y}_{j} ∈ {N}_{k} ( x )} {g}^{cd} ( {y}_{j} - x ) {u}^{c} ( {y}_{j} ) ) )$$
wherein
index c identifies the number of the input channel;
u^{c}(yᵢ) denotes the values inputted in the input ports pᵢ for the c^{th} channel;
mᵢ^{cd} denotes m^{cd}(x,yᵢ) in abbreviated form, the predetermined weights of a first kernel m(·) for the c^{th} input channel and d^{th} output channel;
ωᵢ^{cd} denotes ω^{cd}(x,yᵢ) in abbreviated form, the predetermined weights of a second kernel ω(·) for the c^{th} input channel and d^{th} output channel;
g^{cd} denotes the predetermined weights of third kernel g(·) for the c^{th} input channel and d^{th} output channel; and
the neighborhoods N(x) and Nₖ(x) are common for all channels.

10. A method according to claim 1, wherein the weight values of the first kernel m(·), the weight values of the second kernel ω(·), and the weight values of the third kernel g(·) are the result of a training process of the neural network (NN) and wherein before the training process the stencil of each kernel is predefined.

11. A method according to claim 1, wherein λ is a parameter determined by a training process of the neural network (NN).

12. A method according to claim 1, wherein the non-linear function σ(·) is a predetermined function that depends on one or more parameters wherein said one or more parameters are determined by a training process of the neural network (NN).

13. A use of a deployed neural network (NN) according to step a) of claim 1 wherein the at least one neural unit (NU) is according to feature e) of claim 1.

14. A computer program product comprising instructions which, when the program is executed by a computer, cause the computer to carry out a method according to claim 1.

15. A computer system adapted to carry out a method according to claim 1.
